(19) United States
(12) Patent Application Publication
(10) Pub. No.: US 2025/0341316 A1
(43) Pub. Date: Nov. 6, 2025

(54) CORE COMPONENT WITH COOLING AIR PASSAGE, AND COOKING APPARATUS

(71) Applicant: HUAYU ELECTRICAL APPLIANCE GROUP CO.,LTD., Ningbo (CN)

(72) Inventors: Jiasheng XU, Ningbo (CN); Haifeng LI, Ningbo (CN); Liusheng DU, Ningbo (CN)

(73) Assignee: HUAYU ELECTRICAL APPLIANCE GROUP CO.,LTD., Ningbo (CN)

(21) Appl. No.: 18/794,719

(22) Filed: Aug. 5, 2024

(30) Foreign Application Priority Data
May 6, 2024 (CN) 202420957876.4

(51) Int. Cl. F24C 15/00; A47J 37/06

(52) U.S. Cl. CPC F24C 15/006; A47J 37/0641

(57) ABSTRACT

A core component with a cooling air passage includes a lower core part. The lower core part is provided with at least two cooking cavities, and an isolation air passage is arranged between the two adjacent cooking cavities; cold air outlets are formed between the two adjacent cooking cavities, and air flows into the isolation air passage via the cold air outlets to form an air passage cooling path; and a mixed air vent is formed between the two adjacent cooking cavities, and part of the air in the isolation air passage flows through the mixed air vent. The core component adopts an air passage to realize heat insulation, air guide and especially dynamic cooling of a high-temperature dead corner.

### CROSS-REFERENCE TO RELATED APPLICATIONS

This application claims priority to Chinese Patent Application No. 202420957876.4, filed on May 6, 2024, the content of which is incorporated herein by reference in its entirety.

### TECHNICAL FIELD

The application relates to the technical field of cookware, in particular to a core component with a cooling air passage, and a cooking apparatus.

### BACKGROUND

Air fryers cook food mainly by means of air rather than original hot oil in fryers, and water is blown away from the surface of the food by hot air to fulfill an approximate frying effect on the food. Based on “high-speed air circulation”, the air fryer generates hot air by means of heating tubes in a high-temperature heater and then blows the hot air into a pot to heat food by means of a fan, and the hot air circulates in an enclosed space to fry the food by means of grease of the food, such that water is removed from the food until the surface of the food becomes golden and crispy, thus fulfilling a frying effect.

In actual use, the air fryers, especially double-pot air fryers, can cook different foods at the same time, thus having a wide application range and improving cooking efficiency. However, existing double-pot air fryers use a partition extending from a lower core part to define two cavities, and in actual operation of some air fryers, a high-temperature dead corner is easily formed near the partition, leading to thermal deformation, peptization and other anomalies at this position after long-term use of the air fryers.

### SUMMARY

The objective of the application is to provide a core component with a cooling air passage, which adopts an air passage to realize heat insulation, air guide and especially, dynamic cooling of a high-temperature dead corner.

To fulfill the above objective, the application adopts the following technical solution.

A core component with a cooling air passage comprises a lower core part, wherein the lower core part is provided with at least two cooking cavities, and an isolation air passage is arranged between the two adjacent cooking cavities; cold air outlets are formed between the two adjacent cooking cavities, and air flows into the isolation air passage via the cold air outlets to form an air passage cooling path; and a mixed air vent is formed between the two adjacent cooking cavities, and part of the air in the isolation air passage flows through the mixed air vent, or part of the air in the isolation air passage is mixed with part of air around the lower core part and then flows through the mixed air vent.

The principle and advantages of the technical solution are as follows: at least two cooking cavities are arranged, such that different or identical food materials can be cooked at the same time, the application range is wide, and the cooking efficiency is improved; the isolation air passage is arranged between the two cooking cavities, such that main structures of the two adjacent cooking cavities are disconnected, the isolation air passage can synchronously cool the two adjacent cooking cavities, and the flow path of air can be guided to prevent hot air from being stagnant especially between the two cooking cavities, and a high local temperature caused by continuous heat absorption of air between the two cooking cavities is avoided, thus improving the cooling effect; and the mixed air vent is arranged, such that part of heated air in the isolation air passage can be mixed with part of cold air around the lower core part to be appropriately cooled and is then discharged via the mixed air outlet, thus reducing the temperature around the usage scenario.

Preferably, as an improvement, a connecting portion is arranged between side walls of the two adjacent cooking cavities, the cold air outlets and the mixed air vent are all formed in the connecting portion, and the isolation air passage is defined by the side walls of the two adjacent cooking cavities and the connecting portion.

Beneficial effects: by adopting the above technical solution, the isolation air passage is defined by the side walls of the cooking cavities and the connecting portion; the arrangement of the cold air outlets and the mixed air vent is facilitated, and the cold air outlets and the mixed air vent are all located in the connecting portion, such that the circulation speed of the air flow in the isolation air passage can be increased relatively to allow more heat to be taken away by the air flow quickly, thus further improving the cooling effect under the working condition and further avoiding a high-temperature dead corner.

Preferably, as an improvement, an upper core part is mounted on the lower core part, and the upper core part is provided with at least two housing portions used for mounting cooling fan assemblies; and the housing portions are provided with air inlets and main air outlets.

Beneficial effects: by adopting the above technical solution, the installation of the cooling fan assemblies is facilitated, and under the action of the cooling fan assemblies, an air flow is guided into the housing portions via the air inlets, and most of the air flow is discharged via the main air outlets, thus further improving the cooling effect on the upper core part.

Preferably, as an improvement, air guide vents are formed in the housing portions, and air guide channels are connected between the air guide vents and the isolation air passage; and the cooling fan assemblies suck air via the air inlets and guide part of the air into the air guide channels.

Beneficial effects: by adopting the above technical solution, in actual use, part of air in the housing portions flow sequentially along the air guide vents, the air guide channels, the cold air outlets and the isolation air passage under the action of the cooling air assemblies to drive air in the isolation air passage to flow, thus reducing a cooling dead corner between the two cooling cavities.

Preferably, as an improvement, the upper core part is provided with a lateral mixed air outlet, and the lateral mixed air outlet is connected to the mixed air vent.

Beneficial effects: by adopting the above technical solution, the mixed air vent is arranged, such that part of heated air in the isolation air passage can be mixed with part of cold air around the lower core part to be appropriately cooled and is then discharged via the mixed air outlet, thus reducing the temperature around the usage scenario; moreover, multi-path air circulation is formed in the isolation air passage, thus further improving the overall cooling effect.

Preferably, as an improvement, an air guide part is mounted on the upper core part, and structure holes matched with the cold air outlets and the mixed air vent are formed in the air guide part.

Beneficial effects: by adopting the above technical solution, the sealing effect of the air guide channels, the cold air outlets and the mixed air vent is improved, and cold air is less likely to leak from joints of the air guide channels, the cold air outlets and the mixed air vent, thus guaranteeing a relatively constant delivery rate and speed of cold air.

Preferably, as an improvement, the upper core part is provided with an air guide groove, and the air guide channels are connected to the isolation air passage by means of the air guide groove.

Preferably, as an improvement, partitions are arranged in the air guide groove to separate air from the two air guide channels in the air guide groove.

Beneficial effects: by adopting the above technical solution, air from the two adjacent air guide channels is prevented from being converged in the air guide groove to prevent air flows from being counteracted by each other, and the air flows can enter the isolation air passage via different cold air outlets, such that the circulation speed of the air flow in the isolation air passage is increased to allow more heat to be taken away by the air flow quickly, thus further improving the cooling effect.

The application further provides a cooking apparatus, comprising a cooking apparatus body and the core component with a cooling air passage, wherein the core component with a cooling air passage is mounted on the cooking apparatus body.

Preferably, as an improvement, the cooking apparatus body comprises an outer housing, an inner housing is formed by the lower core part and the upper core part, and cold air channels are formed between the inner housing and the outer housing and connected to the isolation air passage.

Beneficial effects: by adopting the above technical solution, part of the air flow in the isolation air passage continues to move downwards, and when coming in contact with the bottom of the outer housing, part of the air flow is guided and limited by the side walls and bottom walls of the two cooking cavities to be dispersed towards two sides to flow through the outer surface of the lower core part and the outer surface of the upper core part respectively along the cold air channels on two sides, such that a relative internal circulation is formed to reduce the temperature in the cooking apparatus, thus prolonging the service life of the cooking apparatus.

### BRIEF DESCRIPTION OF THE DRAWINGS

FIG. 1 is schematic diagram of a core component with a cooling air passage according to Embodiment 1 of the application.

FIG. 2 is a schematic diagram of the core component with a cooling air passage from another perspective.

FIG. 3 is a schematic sectional view and a schematic diagram of the flow path of part of air according to the application.

FIG. 4 is a schematic sectional view from another perspective and a schematic diagram of the flow path of part of air according to the application.

FIG. 5 is a schematic diagram of an upper core part according to the application.

FIG. 6 is a schematic diagram of the upper core part from another perspective according to the application.

FIG. 7 is a schematic arrangement diagram of an air guide part according to the application.

FIG. 8 is a schematic diagram of a cooking apparatus according to Embodiment 2 of the application.

FIG. 9 is a schematic distribution diagram of cooking cavities according to Embodiment 2 of the application.

FIG. 10 is a schematic sectional view of the cooking apparatus according to Embodiment 2 of the application.

FIG. 11 is a schematic diagram of the flow path of air in the cooking apparatus according to Embodiment 2 of the application.

### DETAILED DESCRIPTION OF THE EMBODIMENTS

The application is described in further detail below with reference to specific embodiments.

### Embodiment 1

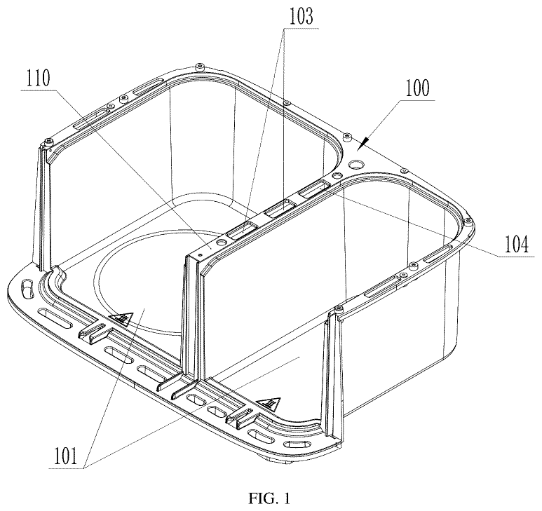

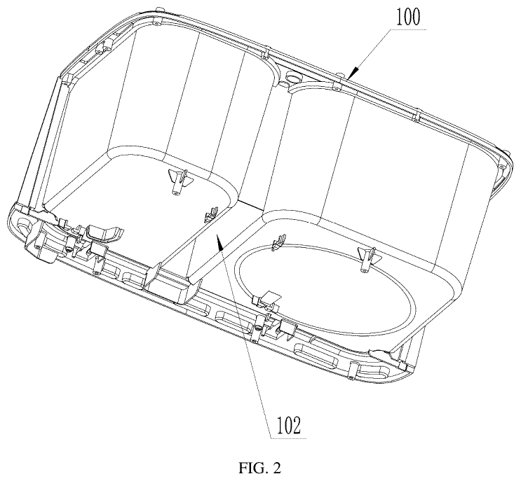

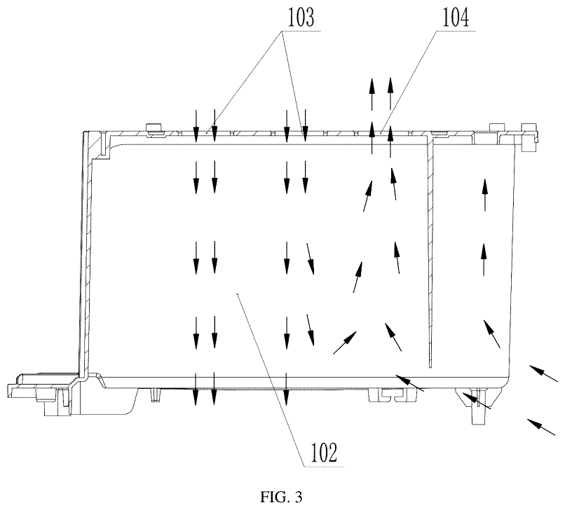

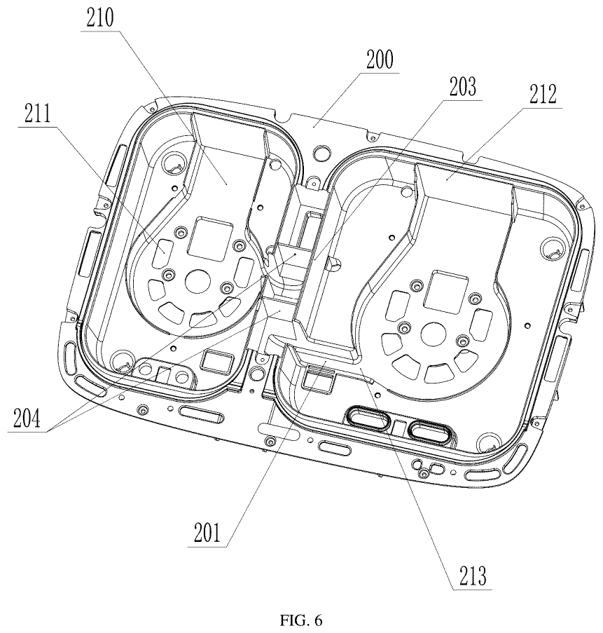

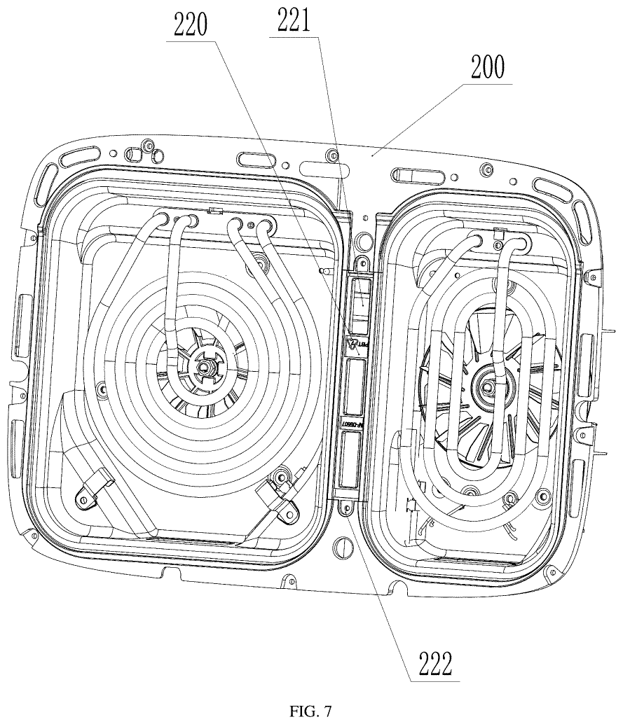

This embodiment is basically shown in FIGS. 1-7.

A core component with a cooling air passage comprises a lower core part 100, wherein the lower core part 100 is provided with at least two cooking cavities 101, and an isolation air passage 102 is arranged between the two adjacent cooking cavities 101.

In this embodiment, the lower core part 100 is preferably provided with two cooking cavities 101.

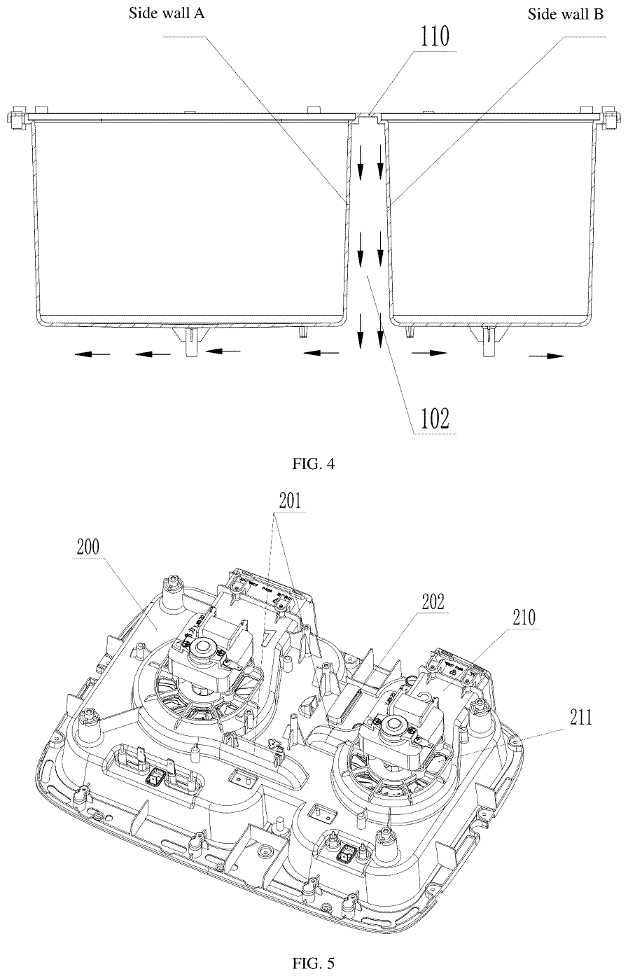

Based on the design of the isolation air passage 102, main structures of the two cooking cavities 101 are disconnected. Specifically, as shown in FIGS. 1 and 4, side faces of the main structures, a side wall A and a side wall B, of the cooking cavities 101 on the left and right are disconnected, such that the isolation air passage 102 can synchronously cool the two adjacent cooking cavities 101, and the flow path of air can be defined and guided to prevent hot air from being stagnant especially between the two cooking cavities 101, such that a high local temperature caused by continuous heat absorption of air between the two cooking cavities 101 is avoided, thus improving the cooling effect.

Specifically, as shown in FIGS. 1 and 4, wherein, the cooking cavity 101 on the left is larger than the cooking cavity 101 on the right, and a cooking pot assembly 300 in the cooking cavity 101 on the left is synchronously larger than a cooking pot assembly 300 in the cooking cavity 101 on the right.

In the above technical solution, cold air outlets 103 are formed between the two adjacent cooking cavities 101, and air flows into the isolation air passage 102 via the cold air outlets 103 to form an air passage cooling path; and a mixed air vent 104 is formed between the two adjacent cooking cavities 101, part of the air in the isolation air passage 102 flows through the mixed air vent 104, or part of the air in the isolation air passage 102 is mixed with part of air around the lower core part 100 and then flows through the mixed air vent 104.

Specifically, two cold air outlets 103 and one mixed air vent 104 are formed between the two adjacent cooking cavities 101, and preferably, the two cold air outlets 103 are adjacent to each other.

To facilitate the arrangement of the cold air outlets 103 and the mixed air vent 104, in this embodiment, a connecting portion 110 is arranged between side walls of the two adjacent cooking cavities 101, that is, upper ends of the two cooking cavities 101 are horizontally connected by means of the connecting portion 110; and the cold air outlets 103 and the mixed air vent 104 are all formed in the connecting portion 110, and the isolation air passage 102 is defined by the side walls of the two adjacent cooking cavities 101 and the connecting portion 110.

An upper core part 200 is mounted on the lower core part 100 and provided with at least two housing portions 210 used for mounting cooling fan assemblies (not shown); and the housing portions 210 are provided with air inlets 211 and main air outlets 212. When assembled, the upper core part 200 and the lower core part 100 are assembled and connected by means of matching bolts or screws.

Preferably, the upper core part 200 is provided with two housing portions 210, and the housing portions 210 protrude from the upper core part 200. In actual use, the cooling fan assemblies are adaptively mounted in the housing portions 210, and air inlet paths of the air inlets 211 are approximately perpendicular to air outlet paths of the main air outlets 212.

Air guide vents 213 are formed in inner edges of the housing portions 210, air guide channels 201 are connected between the air guide vents 213 and the isolation air passage 102, that is, the upper core part 200 is provided with two air guide channels 201, the air guide channels 201 protrude from the upper core part 200, and the two air guide channels 201 are spaced apart from each other; and the cooling fan assemblies suck air via the air inlets 211 and guide parts of the air into the air guide channels 201.

To further improve the cooling effect, in the above technical solution, the upper core part 200 is provided with a lateral mixed air outlet 202, and the lateral mixed air outlet 202 is connected to the mixed air vent 104, that is, air flowing from the mixed air vent 104 flows out via the lateral mixed air outlet 202, such that multi-path air flow circulation is formed in the whole structure, thus further improving the overall cooling effect.

Further, an air guide part 220 is mounted on the upper core part 200, and structure holes 221 matched with the cold air outlets 103 and the mixed air vent 104 are formed in the air guide part 220. In this way, the sealing effect of the air guide channels 201, the cold air outlets 103 and the mixed air vent 104 is improved, and cold air is less likely to leak from joints of the air guide channels 201, the cold air outlets 103 and the mixed air vent 104, thus guaranteeing a relatively constant delivery rate and speed of cold air.

Specifically, the upper core part 200 is provided with an air guide groove 203, and the air guide part 220 is mounted in the air guide groove 203 and provided with provided with two lugs 222. When installed, the air guide part is mounted on the upper core part 200 by means of matching bolts or screws. The air guide channels 201 are connected to the isolation air passage 102 by means of the air guide groove 203.

Further, partitions 204 are arranged in the air guide groove 203. Specifically, two partitions 204 are arranged in the air guide groove 203 to separate air from the two adjacent air guide channels 201 in the air guide groove 203. In this way, air from the two adjacent air guide channels 201 is prevented from being converged in the air guide groove 203 to prevent air flows from being counteracted by each other, and the air flows can enter the isolation air passage 102 via different cold air outlets 103, such that the circulation speed of the air flow in the isolation air passage 102 is increased to allow more heat to be taken away by the air flow quickly, thus further improving the cooling effect. When one of the cooking cavities 101 operates, that is, when the cooling fan assembly on the left or on the right operates separately, the situation where part of cold air flows from the side where the cooling fan assembly operates to the other side where the cooling fan assembly does not operate along the air guide groove 203 can be avoided correspondingly, such that the cold air loss is reduced and the stability of the flow path of cold air is improved, thus improving cooling stability.

### Embodiment 2

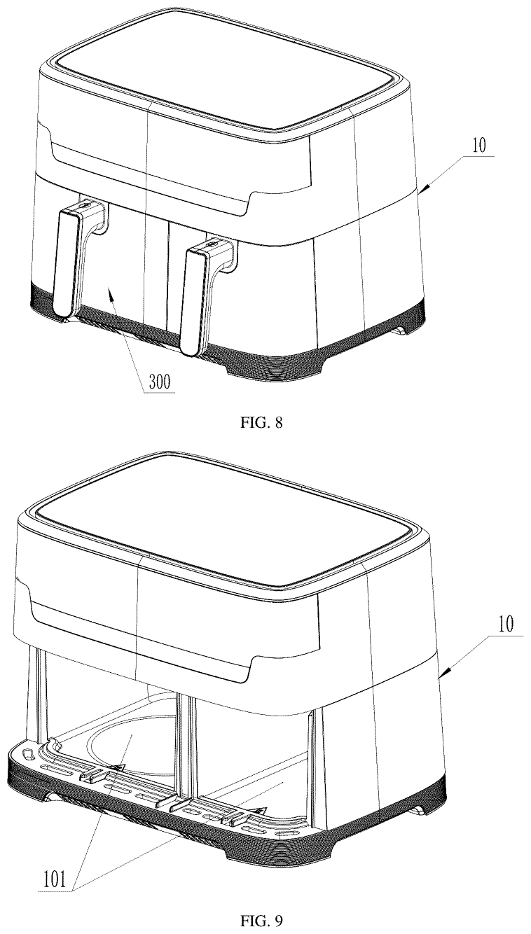

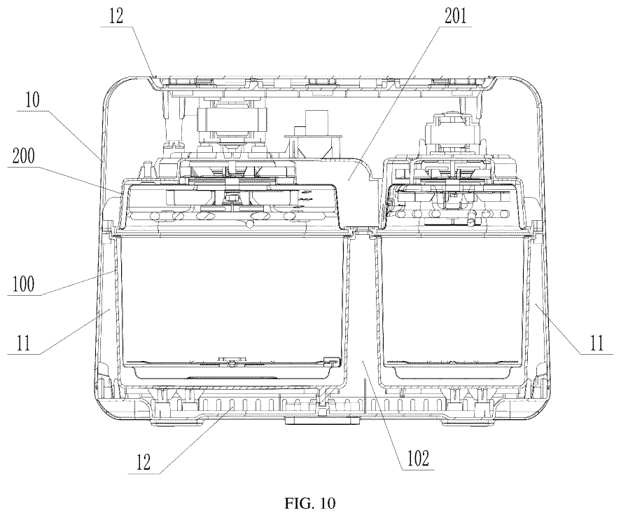

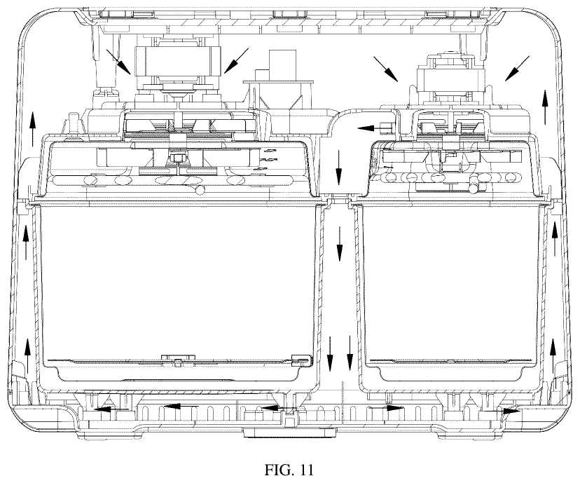

This embodiment is basically shown in FIGS. 8-11.

A cooking apparatus, namely, an air fryer, comprises a cooking apparatus body and the core component with a cooling air passage, wherein the core component with a cooling air passage is mounted on the cooking apparatus body.

Specifically, the cooking apparatus body comprises an outer housing 10, an inner housing is formed by the lower core part 100 and the upper core part 200, the lower core part 100 and the upper core part 200 are arranged in the outer housing 10, and cold air channels 11 are formed between the inner housing and the outer housing 10 and connected to the isolation air passage 102.

Air inlets 12 are formed in the outer housing 10. Specifically, the air inlets 12 are divided into at least two parts, wherein one part of the air inlets 12 are uniformly formed in the bottom of the outer housing 10, and the other part of the air inlets 12 are formed in the top of the outer housing 10 and connected end-to-end to form a rectangular ring; and the air inlets 12 in the bottom of the outer housing 10 are connected to the cold air channels 11.

In specific use, as shown in FIGS. 1-11, the cooling fan assemblies drive air above the upper core part 200 and cold air sucked in via the air inlets 12 in the top of the outer housing 10 to be mixed and then enter the corresponding housing portions 210, wherein under the action of the cooling fan assemblies, part of the mixed air is discharged along the main air outlets 212 which are located in the back side of the outer housing 10, such that users will not be scalded by the air flowing out via the main air outlets 212; and the other part of the mixed air flows into the isolation air passage 102 sequentially along the air guide vents 213, the air guide channels 201, the air guide groove 203 and the cold air outlets 103 to drive air in the isolation air passage 103 to flow cool the side walls of the cooking cavities 101 on two sides.

Due to the structure of the two cooking cavities 101, the cold air outlets 103, the mixed air vent 104 and the cold air channels 11, the air flow is divided into multiple parts, wherein one part of the air flow continues to move downwards and when coming in contact with the bottom of the outer housing 10, is dispersed towards two sides to flow through the outer surface of the whole lower core part 100 and the outer surface of the whole upper core part 200 respectively along the cold air channels 11 on two sides, and when flowing through the bottom of the lower core part 100, the air flow is mixed with cold air sucked in via the air inlets 12 in the bottom of the outer housing 10, then flows to the top of the upper core part 200 together with the cold air, and is guided by the cooling fan assemblies again to participate in a new circulation, such that a relative internal circulation is formed to reduce the temperature in the cooking apparatus.

The other part of the air flow is mixed with cold air sucked in via the air inlets 12 in the bottom of the outer housing 10 and then sequentially passes through the mixed air vent 104, the air guide groove 203 and the lateral mixed air outlet 202 to flow to the top of the upper core part 200, such that cold air circulation is formed. Cooling is realized by multiple internal circulations, and the multiple internal circulations all pass through the isolation air passage 102, such that the isolation air passage 102, as a cooling dead corner, is better cooled.

It should be noted that other internal structures and corresponding control structures of the cooking apparatus in this embodiment belong to the prior art, and the structures and principles will not be expounded in detail here.

The embodiments of the application are described above, and common sense such as known specific technical solutions and/or features in the embodiments are not described in detail. It should be noted that for those skilled in the art, various transformations and improvements can be made without departing from the technical solutions of the application, and all these transformations and improvements should also fall within the protection scope of the application and will not affect the implementation effect of the application and the practicability of the patent. The protection scope of the application should be defined by the claims, and the specific embodiments and other contents in the description are used for explaining the claims.

What is claimed is:

1. A core component with a cooling air passage, comprising a lower core part, wherein:
the lower core part is provided with at least two cooking cavities, and an isolation air passage is arranged between two adjacent cooking cavities;
cold air outlets are formed between the two adjacent cooking cavities, and air flows into the isolation air passage via the cold air outlets to form an air passage cooling path; and
a mixed air vent is formed between the two adjacent cooking cavities, and part of the air in the isolation air passage flows through the mixed air vent, or part of the air in the isolation air passage is mixed with part of air around the lower core part and then flows through the mixed air vent.

2. The core component according to claim 1, wherein a connecting portion is arranged between side walls of the two adjacent cooking cavities, the cold air outlets and the mixed air vent are all formed in the connecting portion, and the isolation air passage is defined by the side walls of the two adjacent cooking cavities and the connecting portion.

3. The core component according to claim 2, wherein an upper core part is mounted on the lower core part, and the upper core part is provided with at least two housing portions used for mounting cooling fan assemblies; and
the housing portions are provided with air inlets and main air outlets.

4. The core component according to claim 3, wherein air guide vents are formed in the housing portions, and air guide channels are connected between the air guide vents and the isolation air passage; and the cooling fan assemblies suck air via the air inlets and guide part of the air into the air guide channels.

5. The core component according to claim 3, wherein the upper core part is provided with a lateral mixed air outlet, and the lateral mixed air outlet is connected to the mixed air vent.

6. The core component according to claim 3, wherein an air guide part is mounted on the upper core part, and structure holes matched with the cold air outlets and the mixed air vent are formed in the air guide part.

7. The core component according to claim 4, wherein the upper core part is provided with an air guide groove, and the air guide channels are connected to the isolation air passage by means of the air guide groove.

8. The core component according to claim 7, wherein partitions are arranged in the air guide groove to separate air from the two air guide channels in the air guide groove.

9. A cooking apparatus, comprising a cooking apparatus body and the core component according to claim 3, wherein the core component is mounted on the cooking apparatus body.

10. The cooking apparatus according to claim 9, wherein the cooking apparatus body comprises an outer housing, an inner housing is formed by the lower core part and the upper core part, and cold air channels are formed between the inner housing and the outer housing and connected to the isolation air passage.
